(19) United States
(12) Patent Application Publication
(10) Pub. No.: US 2004/0038042 A1
(43) Pub. Date: Feb. 26, 2004

(54) Composite element containing polyisocyanate polyaddition products

(76) Inventors: Edmund Stadler, Hollfeld (DE); Jurgen Mertes, Altrip (DE); Heinz Forster, Wolfratshausen (DE); Matthias Hefner, Erdweg (DE); Peter Reinerth, Emmering (DE); Thomas Sandbank, Munchen (DE)

Correspondence Address: Basf Corporation, Patent Department, 1609 Biddle Avenue, Wyandotte, MI, 48192, US

(21) Appl. No.: 10/416,641

(22) PCT Filed: Nov. 10, 2001
(86) PCT No.: PCT/EP01/13023

(30) Foreign Application Priority Data
Nov. 14, 2000 (DE) 100-56-378.3

(51) Int. Cl. B32B 27/00; B32B 27/40

(52) U.S. Cl. 428/425.8

(57) ABSTRACT

The invention relates to composite elements having a structure comprising the following layers: (i) between 2 and 20 mm of metal, (ii) between 10 and 300 mm of polyisocyanate polyaddition products which can be obtained by reacting (a) isocyanates with (b) polymer polyols, as compounds which react with ioscyanates, and (iii) between 2 and 20 mm of metal.

The invention relates to composite elements which have the following layer structure:

(i) from 2 to 20 mm, preferably from 2 to 10 mm, particularly preferably from 5 to 10 mm, of metal,

(ii) from 10 to 300 mm, preferably from 10 to 100 mm, of polyisocyanate polyaddition products obtainable by reacting (a) isocyanates with (b) polymer polyols, as compounds reactive toward isocyanates, and

(iii) from 2 to 20 mm, preferably from 2 to 10 mm, particularly preferably from 5 to 10 mm, of metal.

The invention further relates to a process for producing these composite elements, and to their use. The length dimensions detailed in the introduction for the layers (i), (ii) and (iii) relate to the thickness of the respective layer.

The structural components used in the design of ships, for example hulls and cargo hold covers, or of bridges, roofs or multistorey buildings, have to be able to withstand considerable stresses from external forces. Due to these requirements, structural components of this type are usually composed of metal plates or metal supports, strengthened by appropriate geometry or suitable struts. Due to increased safety standards, tanker hulls are therefore usually composed of an inner and an outer hull, each hull being built up from steel plates of 15 mm thickness, connected to one another via steel struts about 2 m in length. Since these steel plates are exposed to considerable forces, both the outer and the inner steel shells are reinforced by welded-on reinforcing elements. Disadvantages of these traditional structural components are the considerable amounts of steel required and the time-consuming and labor-intensive method of manufacture. In addition, structural components of this type have considerable weight, reducing the tonnage of the ships and increasing fuel usage. Traditional structural components of this type based on steel also require heavy maintenance, since both the outer surface and the surfaces of the steel components between the outer and the inner shells regularly have to be protected from corrosion.

Known substitutes for designs based on steel are SPS elements (Sandwich Plate Systems), comprising a composite made from metal and plastic. The adhesion of the plastic to the two metal layers produces composite elements with remarkable advantages over known designs based on steel. DE-A 198 25 083, DE-A 198 25 085, DE-A 198 25 084, DE-A 198 25 087 and DE-A 198 35 727 include general disclosure of SPS elements. The potential for improvement in the production of these composite elements consists in particular in controlling the heat of reaction during preparation of the plastic between the metal layers, and in particular the resultant expansion of the system, and also controlling the subsequent shrinkage during and after cooling, but without any significant impairment here of the adhesion of the plastic to the metal layers, or of physical properties.

It is an object of the present invention, therefore, to develop new composite elements which have excellent adhesion of (ii) to (i) and (iii) both during the preparation of the plastic and also in particular after cooling and after the resultant shrinkage of (ii). The composite elements produced here should resist large stresses caused by external forces and be capable of application in shipbuilding, bridge construction, or the construction of multistorey buildings, for example. The structural components to be developed, also known as composite elements, are intended to serve as replacement for known steel structures and in particular have advantages with regard to weight, production process, and maintenance resources required.

We have found that this object is achieved by the composite elements described at the outset.

The use of polymer polyols in particular can markedly reduce the shrinkage of the polyisocyanate polyaddition product, for example of the polyurethane, and thus lead to improved adhesion of (ii) to (i) and (iii). Other preferred measures which may be used, where appropriate, to reduce the shrinkage are the use of blowing agents (f) and/or gases (c).

Preference is given to composite elements which have the following layer structure:

(i) from 2 to 20 mm, preferably from 5 to 10 mm, of metal,

(ii) from 10 to 300 mm, preferably from 10 to 100 mm, of polyisocyanate polyaddition products with a density of 350 to 1100 kg/m³, obtainable by reacting (a) isocyanates with (b) polymer polyols, as compounds reactive toward isocyanates, in the presence of (f) blowing agents and/or from 1 to 50% by volume, based on the volume of the polyisocyanate polyaddition products, of at least one gas (c), and also, where appropriate, (d) catalysts and/or (e) auxiliaries and/or additives,

(iii) from 2 to 20 mm, preferably from 5 to 10 mm, of metal.

The polymer polyols used may be compounds well known from polyurethane chemistry.

The polymer polyols are also well known in the literature in the form of polymer polyetherols, or graft polyetherols. These comprising organic vinyl polymer fillers. Graft polyetherols are stable dispersions of usually solid vinyl polymers, such as styrene-acrylonitrile copolymers, or of homopolymers of these, or else of other vinyl monomers, e.g. vinyl acetate, vinyl chloride, or acrylates, in a conventional carrier polyetherol, e.g. the polyether polylols described later in this specification. The graft polyetherols are generally prepared by known processes, for example by in-situ polymerization of the vinyl monomer(s) in the carrier polyol, and a graft polyetherol therefore comprises graft copolymers, i.e. vinyl-polymer-modified carrier polyol, alongside the unmodified carrier polyol and the vinyl polymers. The graft copolymer serves as emulsifier for stabilizing the carrier polyol/vinyl polymer dispersion.

The viscosity of the graft polyether polyols rises relatively rapidly with the content of vinyl polymer. The maximum proportion of vinyl polymer in the carrier polyol is therefore preferably about 60% by weight, but typically from 10 to 50% by weight, and with preference from 30 to 45% by weight, based in each case on the total weight.

Carrier polyols which may be used are polyoxypropylene polyetherols of functionality two, three, or higher, or polyoxypropylene polyoxyethylene polyetherols with molar mass from 1000 to 10 000 g/mol, preferably with molar mass from 2000 to 8000 g/mol. Typical carrier polyols used are: glycerol (gly) and/or trimethylolpropane (TMP)-propylene oxide (PO) or gly(or, respectively, TMP)—PO/ethylene oxide (EO), or gly(or, respectively, TMP)—PO-EO or gly(or, respectively, TMP)-PO/EO-EO or gly(or, respectively, TMP)—PO/EO-PO.

The polymer polyols preferably used are styrene-acrylonitrile graft polyols, in particular reactive graft polyether polyols having a hydroxyl value of from 15 to 50 mg KOH/g, preferably from 20 to 30 mg KOH/g, in particular from 25 mg KOH/g, preferably prepared from a glycerol-started polyoxypropylene polyoxyethylene polyol as carrier polyol, and with a solids content of from 25 to 35% by weight, preferably from 30 to 33% by weight, composed of a styrene/acrylonitrile copolymer (e.g. Lupranol® 4100 from BASF Aktiengesellschaft), or else reactive graft polyether polyols having a hydroxyl value of from 15 to 25 mg KOH/g, preferably from 17 to 21 mg KOH/g, preferably prepared from a glycerol-started polyoxypropylene polyoxyethylene polyol as carrier polyol and with a solids content of from 40 to 50% by weight, preferably 45% by weight, composed of a styrene/acrylonitrile copolymer (e.g. Lupranol® 4800 from BASF Aktiengesellschaft).

The polymer polyols described may be used as sole compounds reactive toward isocyanates or in a mixture with well known compounds reactive toward isocyanates, these being described at a later stage in this specification. The proportion of the polymer polyols is preferably from 10 to 100% by weight, particularly preferably from 30 to 80% by weight, based in each case on the weight of all of the compounds (b) reactive toward isocyanates.

Compared with the use of inorganic fillers, the use of these polymer polyols has the following advantages:

simpler preparation of the filled formulation (incorporation of the filler by stirring)

stable dispersion (no filler settlement)

no marked viscosity rise at high filler concentrations, i.e. the system is simpler to process and has better flowability

no marked increase in elastomer density.

The polyisocyanate polyaddition products (ii) of the composite elements produced according to the invention preferably have a modulus of elasticity of >275 MPa in the temperature range from −40 to +90° C. (to DIN 53457), adhesion to (i) and (iii) of >4 MPa (to DIN 53530), extension of >30% in the temperature range from −40 to +90° C. (to DIN 53504), tensile strength of >20 MPa (to DIN 53504), and compressive strength of >20 MPa (to DIN 53421).

A particular advantage possessed by composite elements of the invention, alongside excellent mechanical properties, is that it is also possible to obtain composite elements with very large dimensions. Composite elements of this type have previously been difficult to obtain by preparing a plastic (ii) between two metal plates (i) and (iii), due to the shrinkage of the plastic (ii) during and after its preparation. The shrinkage of the plastic (ii), for example of the polyisocyanate polyaddition products, causes partial break-away of the plastic (ii) from the metal plates (i) and/or (iii), whereas very complete and very good adhesion of the plastic (ii) to the metal plates (i) and/or (iii) is particularly important for the mechanical properties of a composite element of this type.

In one method of producing the composite elements of the invention, polyisocyanate polyaddition products (ii), usually polyurethanes which may, where appropriate, have urea structures and/or isocyanurate structures, are prepared between (i) and (iii) by reacting (a) isocyanates with (b) polymer polyols, preferably in the presence of blowing agents (f) and preferably of from 1 to 50% by volume, based on the volume of the polyisocyanate polyaddition products, of at least one gas (c), and also particularly preferably of (d) catalysts, and/or of (e) auxiliaries and/or additives, where the polyaddition products adhere to (i) and (iii).

The reaction is preferably carried out in a closed mold, i.e. when the starting components for preparing (ii) are placed between (i) and (iii). The latter are in a mold, which is sealed after all of the starting components have been introduced. After the starting components have reacted to prepare (ii), the composite element may be removed from the mold.

The surfaces of (i) and/or (iii) to which (ii) adheres once the composite elements have been produced may preferably be blasted with sand or with steel shot. Usual methods may be used for this sandblasting. For example, the surfaces may be blasted with conventional sand at high pressure, thus being cleaned and roughened, for example. Suitable equipment for this type of treatment is available commercially.

This treatment of the surfaces of (i) and (iii) which are in contact with (ii) after the reaction of (a) with (b) leads to markedly improved adhesion of (ii) to (i) and (iii). The sandblasting is preferably carried out directly prior to the introduction of the components for preparing (ii) into the space between (i) and (iii). The surfaces of (i) and (iii) to which (ii) is to adhere are preferably free from inorganic and/or organic adhesion-reducing substances, such as oils or fats or substances generally known to be mold-release agents.

After the preferred treatment of the surfaces of (i) and (iii), it is preferable for these layers to be fixed in a suitable arrangement, such as parallel to one another. The distance selected is usually such that the space between (i) and (iii) has a thickness of from 10 to 100 mm. One way of fixing (i) and (iii) is by using spacers. The edges of the intermediate space may preferably be sealed off in such a way that although the space between (i) and (iii) can be charged with (a), (b) and (f), and also, where appropriate, (d) and/or (e) and/or (c), these components are prevented from flowing out. The space may be sealed off using conventional plastic films or metal foils, and/or metal plates, which can also serve as spacers.

(i) and (iii) may be either vertical or horizontal when the space between (i) and (iii) is charged with material.

The charging of the space between (i) and (iii) with (a) and (b) and, where appropriate, with the other starting materials, may be carried out using conventional conveying devices, preferably continuously, for example using high- or low-pressure machinery, preferably high-pressure machinery.

The conveying rate may be varied depending on the volume to be charged. In order to ensure uniform and thorough curing of (ii), the conveying rate and conveying device selected are such that the components for preparing (ii) can be charged to the appropriate space within a period of from 0.5 to 20 min.

The layers (i) and (iii) used are usually plates and may be conventional metals, such as iron, conventional steel, any type of refined steel, aluminum and/or copper.

When producing the novel composite elements, both (i) and (iii) may be used in coated form, for example primed or otherwise surface-coated and/or coated with conventional plastics. (i) and (iii) are preferably used uncoated, and particularly preferably after cleaning by conventional sandblasting, for example.

The preparation of the polyisocyanate polyaddition products (ii), usually polyurethane products and, where appropriate, polyisocyanurate products, in particular polyurethane elastomers, by reacting (a) isocyanates with (b) compounds reactive toward isocyanates, where appropriate in the presence of (f), (d) catalysts and/or (e) auxiliaries and/or additives and/or (c) has been described many times.

The starting materials (a), (b), (c), (d), (e) and (f) for the process of the invention are described below by way of example:

Isocyanates (a) which may be used are the aliphatic, cycloaliphatic, araliphatic and/or aromatic isocyanates known per se, preferably diisocyanates which, where appropriate, may have been biuretized and/or isocyanuratized by well-known processes. Individual examples are: alkylene diisocyanates having from 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, lysine ester diisocyanates (LDI), hexamethylene 1,6-diisocyanate (HDI), cyclohexane 1,3- and/or 1,4-diisocyanate, hexahydrotolylene 2,4- and 2,6-diisocyanate, and also the corresponding isomer mixtures, dicyclohexylmethane 4,4′-, 2,2′- and 2,4′-diisocyanate, and also the corresponding isomer mixtures,

1-isocyanato-3,3,5-trimethyl-5-isocyanatomethylcyclohexane (IPDI), tolylene 2,4- and/or 2,6-diisocyanate (TDI), diphenylmethane 4,4′-, 2,4′- and/or 2,2′-diisocyanate (MDI), polyphenyl polymethylene polyisocyanates, and/or mixtures comprising at least two of the isocyanates mentioned. The process of the invention may also use di- and/or polyisocyanates containing ester groups, urea groups, allophanate groups, carbodiimide groups, uretdione groups and/or urethane groups. Preference is given to the use of 2,4′-, 2,2′-, and/or 4,4′-MDI and/or polyphenyl polymethylene polyisocyanates, particularly preferably mixtures comprising polyphenyl polymethylene polyisocyanates and at least one of the MDI isomers.

Examples of compounds (b) which may be used in addition to the polymer polyols of the invention and are reactive toward isocyanates are those in which the groups reactive toward isocyanates are hydroxyl, thiol and/or primary and/or secondary amino, usually compounds having a molar mass of from 60 to 10 000 g/mol, e.g. polyols selected from the group consisting of polyether polyalcohols, polyester polyalcohols, polythioether polyols, polyacetals containing hydroxyl groups and aliphatic polycarbonates containing hydroxyl groups, and mixtures of at least two of the polyols mentioned. The functionality of these compounds, which are well known to the skilled worker, toward isocyanates is usually from 2 to 6 and their molecular weight is usually from 400 to 8000.

Examples of polyether polyalcohols are those obtainable using known technology by adding alkylene oxides, such as tetrahydrofuran, propylene 1,3-oxide, butylene 1,2- or 2,3-oxide, styrene oxide, or preferably ethylene oxide and/or propylene 1,2-oxide, to conventional starter substances. Examples of starter substances which may be used are known aliphatic, araliphatic, cycloaliphatic and/or aromatic compounds containing at least one, preferably from 2 to 4, hydroxyl group(s) and/or at least one, preferably from 2 to 4, amino group(s). Examples of compounds which may be used as starter substances are ethanediol, diethylene glycol, 1,2- or 1,3-propanediol, 1,4-butanediol, 1,5-pentanediol, 1,6-hexanediol, 1,7-heptanediol, glycerol, trimethylolpropane, neopentyl glycol, sugars, such as sucrose, pentaerythritol, sorbitol, ethylenediamine, propanediamine, neopentanediamine, hexamethylenediamine, isophoronediamine, 4,4′-diaminodicyclohexylmethane, 2-(ethylamino)ethylamine, 3-(methylamino)propylamine, diethylenetriamine, dipropylenetriamine and/or N,N′-bis(3-aminopropyl)ethylenediamine.

The alkylene oxides may be used individually or alternating in succession, or as mixtures. Preference is given to the use of alkylene oxides which give primary hydroxyl groups in the polyol. Particular preference is given to the use of polyols which have been alkoxylated with ethylene oxide at the end of the alkoxylation and therefore have primary hydroxyl groups.

One way of preparing suitable polyester polyols is to start from organic dicarboxylic acids having from 2 to 12 carbon atoms, preferably aliphatic dicarboxylic acids having from 4 to 6 carbon atoms, and from polyhydric alcohols, preferably diols, having from 2 to 12 carbon atoms, preferably from 2 to 6 carbon atoms. The polyester polyols preferably have a functionality of from 2 to 4, in particular from 2 to 3, and a molecular weight of from 480 to 3000, preferably from 600 to 2000 and in particular from 600 to 1500.

The use of polyether polyalcohols offers considerable advantages by way of improved resistance of the polyisocyanate polyaddition products to hydrolytic cleavage, and through their lower viscosity, in each case compared with polyester polyalcohols. The improved resistance to hydrolysis is particularly advantageous for use in shipbuilding. The lower viscosity of the polyether polyalcohols and of the reaction mixture for preparing (ii) comprising the polyether polyalcohols permits simpler and more rapid charging of the space between (i) and (iii) with the reaction mixture for producing the composite elements. Low-viscosity liquids give a considerable advantage in shipbuilding since the dimensions, in particular of structural components, are substantial.

Other suitable compounds reactive toward isocyanates are substances which have a hydrocarbon skeleton having from 10 to 40 carbon atoms and from 2 to 4 groups reactive toward isocyanates. For the purposes of the invention, a hydrocarbon skeleton is a sequence of carbon atoms which is uninterrupted and not, as is the case for example with ethers, interrupted by oxygen atoms. Examples of substances of this type which can be used and are also termed (b3) below are castor oil and its derivatives.

In addition to the abovementioned compounds with a usual molecular weight of from 400 to 8000, other compounds which are reactive toward isocyanates and which may be used, where appropriate, as chain extenders and/or crosslinking agents in the process of the invention are diols and/or triols with molecular weights of from 60 to <400. It may moreover prove advantageous for modifying mechanical properties, such as hardness, to add chain extenders, crosslinking agents or, where appropriate, mixtures of these. The chain extenders and/or crosslinking agents preferably have a molecular weight of from 60 to 300. Examples of possible compounds are aliphatic, cycloaliphatic and/or araliphatic diols having from 2 to 14 carbon atoms, preferably from 4 to 10 carbon atoms, for example ethylene glycol, 1,3-propanediol, 1,10-decanediol, o-, m- or p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, glycerol and trimethylolpropane, low-molecular-weight polyalkylene oxides containing hydroxyl groups and based on ethylene oxide and/or on propylene 1,2-oxide and on the abovementioned diols and/or triols as starter molecules and/or diamines, such as diethyltoluenediamine and/or 3,5-dimethylthio-2,4-toluenediamine.

If chain extenders, crosslinking agents or mixtures of these are used for preparing the polyisocyanate polyaddition products, these are usefully used in amounts of from 0 to 30% by weight, preferably from 1 to 30% by weight, based on the weight of all of the compounds (b) used which are reactive toward isocyanates.

Other compounds which may be used as (b) in order to optimize the progress of curing during the preparation of (ii) are aliphatic, araliphatic, cycloaliphatic and/or aromatic carboxylic acids. Examples of carboxylic acids of this type are formic acid, acetic acid, succinic acid, oxalic acid, malonic acid, glutaric acid, adipic acid, citric acid, benzoic acid, salicylic acid, phenylacetic acid, phthalic acid, toluenesulfonic acid and derivatives of the acids mentioned, isomers of the acids mentioned and any desired mixture of the acids mentioned. The proportion of these acids by weight may be from 0 to 5% by weight, preferably from 0.2 to 2% by weight, based on the total weight of (b).

The use of amine-started polyether polyalcohols can also improve the curing performance of the reaction mixture for preparing (ii). The compounds (b) used, and also the other components for preparing (ii), preferably have a very low water content, in order to avoid formation of carbon dioxide via reaction of the water with isocyanate groups.

Component (c) used for preparing (ii) may be well-known compounds with a boiling point below −50° C. at a pressure of 1 bar, for example air, carbon dioxide, nitrogen, helium, and/or neon. It is preferable to use air. Component (c) is preferably inert toward component (a), particularly preferably toward components (a) and (b), i.e. the gas has hardly any, and preferably no, detectable reactivity toward (a) or (b). The use of the gas (c) differs fundamentally from the use of conventional blowing agents for producing foamed polyurethanes. Whereas conventional blowing agents (f) are used in liquid form, or in the case of gaseous physical blowing agents have solubility to levels of up to a few percent in the polyol component, and during the reaction either evaporate due to the heat generated or else, in the case of water, evolve gaseous carbon dioxide on reaction with the isocyanate groups, component (c) in the present invention is preferably gaseous before it is used, in the form of an aerosol, for example, in the polyol component.

The catalysts (d) which may be used include well-known compounds which markedly accelerate the reaction of isocyanates with the compounds reactive toward isocyanates. The total catalyst content used is preferably from 0.001 to 15% by weight, in particular from 0.02 to 6% by weight, based on the weight of all of the isocyanate-reactive compounds used. Examples of compounds which may be used are: triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and/or N-ethylmorpholine, N-cyclohexylmorpholine, N,N,N′,N′-tetramethylethylenediamine, N,N,N′,N′-tetramethylbutanediamine, N,N,N′,N′-tetramethyl-1,6-hexanediamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, iron(II) chloride, zinc chloride, lead octoate, and preferably tin salts, such as tin dioctoate, diethyltin hexoate, dibutyltin dilaurate and/or dibutyldilauryltin mercaptide, 2,3-dimethyl-3,4,5,6-tetrahydropyrimidine, tetraalkylammonium hydroxides, such as tetramethylammonium hydroxide, alkali metal hydroxides, such as sodium hydroxide, alkali metal alcoholates, such as sodium methoxide or potassium isopropoxide, and/or alkali metal salts of long-chain fatty acids having from 10 to 20 carbon atoms and, where appropriate, laterally positioned OH groups.

It has proven very advantageous to carry out the preparation of (ii) in the presence of (d) in order to accelerate the reaction.

Where appropriate, additives and/or auxiliaries (e) may be incorporated into the reaction mixture for preparing the polyisocyanate polyaddition products (ii). Examples which may be mentioned are fillers, surface-active substances, dyes, pigments, flame retardants, agents to protect against hydrolysis, and substances with fungistatic or bacteriostatic action, and foam stabilizers.

Examples of surface-active substances which may be used are those compounds which serve to promote the homogenization of the starting materials and which, where appropriate, are also suitable for regulating the structure of the plastics. Examples which may be mentioned are emulsifiers, such as the sodium salts of castor oil sulfates or of fatty acids, and also salts of fatty acids with amines, e.g. diethylammonium oleate, diethanolammonium stearate, diethanolammonium ricinoleate, and salts of sulfonic acids, e.g. the alkali metal or ammonium salts of dodecylbenzene- or dinaphthylmethanedisulfonic acid and ricinoleic acid. The amounts usually used of the surface-active substances are from 0.01 to 5% by weight, based on 100% by weight of all of the isocyanate-reactive compounds (b) used.

Examples of suitable flame retardants are tricresyl phosphate, tris(2-chloroethyl) phosphate, tris(2-chloropropyl) phosphate, tris(1,3-dichloropropyl) phosphate, tris(2,3-dibromopropyl) phosphate, tetrakis(2-chloroethyl) ethylenediphosphate, dimethyl methanephosphonate, diethyl diethanolaminomethylphosphonate and also commercially available halogen-containing flame-retardant polyols. Compounds other than the abovementioned halogen-substituted phosphates which may be used to render the polyisocyanate polyaddition products flame-retardant are inorganic or organic flame retardants such as red phosphorus, alumina hydrate, antimony trioxide, arsenic oxide, ammonium polyphosphate and calcium sulfate, expandable graphite, and cyanuric acid derivatives, e.g. melamine, and mixtures of at least two flame retardants, e.g. ammonium polyphosphates and melamine, and also, where appropriate, corn starch or ammonium polyphosphate, or melamine and expandable graphite and/or, where appropriate, aromatic polyesters. It has generally proven useful to use from 5 to 50% by weight, preferably from 5 to 25% by weight, of the flame retardants mentioned, based on the weight of all of the isocyanate-reactive compounds used.

For the purposes of the invention, fillers, in particular reinforcing fillers, are reinforcing agents, weighting agents, agents for improving abrasion performance in paints, coating agents, etc., and the usual organic or inorganic fillers known per se. Individual examples which may be mentioned are: inorganic fillers, such as silicate minerals, for example phyllosilicates, such as antigorite, serpentine, hornblendes, amphibols, chrisotile and talc, metal oxides, such as kaolin, aluminas, titanium oxides and iron oxides, metal salts, such as chalk, barite, and inorganic pigments, such as cadmium sulfide and zinc sulfide, and also glass. Preference is given to the use of kaolin (China clay), aluminum silicate and coprecipitates of barium sulfate and aluminum silicate, and also to natural or synthetic fibrous minerals, such as wollastonite, and short metal or glass fibers. Examples of possible organic fillers are: carbon, melamine, rosin, cyclopentadienyl resins and graft polymers, and also cellulose fibers, polyamide fibers, polyacrylonitrile fibers, polyurethane fibers, and polyester fibers based on aromatic and/or on aliphatic dicarboxylic esters, and in particular carbon fibers. The inorganic or organic fillers may be used individually or as a mixture.

It is preferable to use from 10 to 70% by weight of fillers, based on the weight of (ii), as auxiliaries (e) and/or additives in preparing (ii). The fillers used preferably comprise talc, kaolin, calcium carbonate, barite, glass fibers and/or glass microbeads. The dimensions selected for the particles of the fillers are preferably such as not to impede introduction of the components for preparing (ii) into the space between (i) and (iii). The particle sizes of the fillers are particularly preferably <0.5 mm.

It is preferable for the fillers to be used in a mixture with the polyol component in the reaction to prepare the polyisocyanate polyaddition products.

It is preferable for conventional, commercially available foam stabilizers well-known to the skilled worker to be used as (e) for preparing (ii), for example well-known polysiloxane-polyoxyalkylene block copolymers, e.g. Tegostab 2219 from Goldschmidt. When preparing (ii), the proportion of these foam stabilizers is preferably from 0.001 to 10% by weight, particularly preferably from 0.01 to 10% by weight, and in particular from 0.01 to 2% by weight, based on the weight of the components (b), (e) and, if used, (d) used to prepare (ii). The use of these foam stabilizers stabilizes the component (c) in the reaction mixture for preparing (ii).

Blowing agents well known in polyurethane chemistry may be used as blowing agents (f), for example physical and/or chemical blowing agents. These physical blowing agents generally have a boiling point above −50° C. at a pressure of 1 bar. Examples of physical blowing agents are CFCs, HCFCs, HFCS, aliphatic hydrocarbons, cycloaliphatic hydrocarbons, for example in each case having from 4 to 6 carbon atoms, and mixtures of these substances, for example trichlorofluoromethane (boiling point 24° C.), chlorodifluoromethane (boiling point −40.8° C.), dichlorofluoroethane (boiling point 32° C.), chlorodifluoroethane (boiling point −9.2° C.), dichlorotrifluoroethane (boiling point 27.1° C.), tetrafluoroethane (boiling point −26.5° C.), hexafluorobutane (boiling point 24.6° C.), isopentane (boiling point 28° C.), n-pentane (boiling point 36° C.), and cyclopentane (boiling point 49° C.).

Examples of chemical blowing agents which may be used, i.e. blowing agents which use a reaction, for example with isocyanate groups, to form gaseous products are water, compounds in which water of hydration is present, carboxylic acids, tert-alcohols, e.g. tert-butanol, and carbamates, for example the carbamates described in EP-A 1000955, in particular in lines 5 to 31 on page 2 and lines 21 to 42 on page 3, carbonates, e.g. ammonium carbonate, and/or ammonium hydrogencarbonate and/or guanidine carbamate.

Water and/or carbamates are preferably used as blowing agents (f).

The amount of the blowing agents (f) preferably used is sufficient to obtain the preferred density of (ii). This can be determined using simple routine experiments very familiar to the skilled worker. The amount of the blowing agents (f) used is particularly preferably from 0.05 to 10% by weight, in particular from 0.1 to 5% by weight, based in each case on the total weight of the polyisocyanate polyaddition products.

By definition, the weight of (ii) corresponds to the weight of the components (a), (b) and (c) and, where appropriate, (d) and/or (e) used to prepare (ii).

To prepare the polyisocyanate polyaddition products of the invention, the isocyanates and the isocyanate-reactive compounds are reacted in amounts such that the ratio of equivalents of NCO groups in the isocyanates (a) to the total of the reactive hydrogen atoms in the isocyanate-reactive compounds (b) and, where appropriate, (f) is from 0.85:1 to 1.25:1, preferably from 0.95:1 to 1.15:1 and in particular from 1:1 to 1.05:1. If (ii) contains at least some isocyanurate groups, the ratio selected between NCO groups and the total of the reactive hydrogen atoms is usually from 1.5:1 to 60:1, preferably from 1.5:1 to 8:1.

The polyisocyanate polyaddition products are usually prepared by the one-shot process or by the prepolymer process, for example with the aid of high-pressure or low-pressure technology.

It has proven particularly advantageous to use the two-component process and to combine the compounds (b) reactive toward isocyanates, the blowing agents (f) if used, the catalysts (d) if used, and/or auxiliaries and/or additives (e) in component (A), and preferably to mix these intimately with one another, and to use the isocyanates (a) as component (B).

Component (c) may be introduced into the reaction mixture comprising (a), (b) and, if used, (f), (d) and/or (e), and/or into the individual components described above: (a), (b), (A) and/or (B). The component which is mixed with (c) is usually liquid. It is preferable for the components to be mixed into component (b).

The mixing of the appropriate component with (c) may take place by well-known processes. For example, (c) may be introduced into the appropriate component by way of well-known feeding equipment, such as air-feeding equipment, preferably underpressure, for example from a pressure vessel or compressed by a compressor, e.g. by way of a nozzle. There is preferably substantial and thorough mixing of the corresponding components with (c), and the size of the bubbles of gas (c) in the usually liquid component is therefore preferably from 0.0001 to 10 mm, particularly preferably from 0.0001 to 1 mm.

The content of (c) in the reaction mixture for preparing (ii) may be determined by way of the density of the reaction mixture using well-known measurement devices in the return line of the high-pressure machinery. The content of (c) in the reaction mixture may preferably be regulated automatically on the basis of this density, by way of a control unit. Even at very low circulation rates, the component density can be determined on-line and regulated during conventional circulation of the material within the machinery.

One way of producing the sandwich element is to seal off, except for a feed and a discharge for the starting components, the space between (i) and (iii) which is to be charged with the starting components for preparing (ii), and to charge the starting components (a), (b) and, if used, (c), (d), (f) and/or (e), preferably mixed, into the space between (i) and (iii) via the feed, preferably using conventional high-pressure machinery.

The starting components are usually mixed at from 0 to 100° C., preferably from 20 to 60° C., and, as already described, introduced into the space between (i) and (iii). They may be mixed mechanically using a stirrer or a mixing screw, but preferably by the countercurrent method usual in high-pressure machinery, in which a jet of component A and a jet of component B, each at high pressure, encounter one another in the mixing head, and mix. The jet of one or other component may also have been divided. The reaction temperature, i.e. the temperature at which the reaction takes place, is usually >20° C., preferably from 50 to 150° C.

The composite elements of the invention which can be produced by the process of the invention have the following advantages over known structures:

When comparison is made among polyurethanes, the use of the polymer polyols brings about lower shrinkage during cooling of the system after the reaction. This achieves better adhesion to (i) and (iii), since no break-away occurs during cooling.

The preferred use of (c) and/or (f) can provide further protection against shrinkage of (ii) and resultant impairment of the adhesion of (ii) to (i) and (iii).

The composite elements obtainable according to the invention are therefore used mainly in fields where there is a need for structural elements which withstand large forces, for example as structural components in shipbuilding, e.g. in hulls, for example as double hulls with an outer and an inner wall, or cargo hold covers, cargo hold partitions or cargo doors, or in civil engineering works, such as bridges, or as structural components in the construction of buildings, in particular for multistorey buildings.

The composite elements of the invention should not be confused with traditional sandwich elements which comprise a rigid polyurethane foam and/or a rigid polyisocyanurate foam as core and are usually used for thermal insulation. The comparatively low mechanical load-bearing capacity of these known sandwich elements would make them unsuitable for the application sectors mentioned.

Preference is given to compact polyisocyanate polyaddition products, i.e. products not composed of a network of gas-filled cells connected to one another via fillets and cell walls.

We claim:

1. A composite element which has the following layer structure:
(i) from 2 to 20 mm of metal,
(ii) from 10 to 300 mm of polyisocyanate polyaddition products obtainable by reacting (a) isocyanates with (b) polymer polyols comprising organic vinyl polymer fillers, as compounds reactive toward isocyanates, and
(iii) from 2 to 20 mm of metal.

2. A composite element as claimed in claim 1 comprising styrene-acrylonitrile graft polyols as (b).

3. A composite element which has the following layer structure:
(i) from 2 to 20 mm of metal,
(ii) from 10 to 300 mm of polyisocyanate polyaddition products with a density of 350 to 1100 kg/m³, obtainable by reacting (a) isocyanates with (b) polymer polyols comprising organic vinyl polymer fillers, as compounds reactive toward isocyanates, in the presence of (f) blowing agents and/or from 1 to 50% by volume, based on the volume of the polyisocyanate polyaddition products, of at least one gas (c), and also, where appropriate, (d) catalysts and/or (e) auxiliaries and/or additives,
(iii) from 2 to 20 mm of metal.

4. A process for producing composite elements as claimed in any of claims 1 to 3, which comprises, between (i) and (iii), preparing polyisocyanate polyaddition products (ii) which adhere to (i) and (iii), by reacting (a) isocyanates with (b) compounds reactive toward isocyanates.

5. A composite element obtainable by a process as claimed in claim 4.

6. The use of composite elements as claimed in any of claims 1 to 3 or 5 as structural components in shipbuilding or in buildings.

7. A ship or a building comprising composite elements as claimed in any of claims 1 to 3 or 5. Composite elements which have the following layer structure:
(i) from 2 to 20 mm of metal,
(ii) from 10 to 300 mm of polyisocyanate polyaddition products obtainable by reacting (a) isocyanates with (b) polymer polyols as compounds reactive toward isocyanates, and
(iii) from 2 to 20 mm of metal.
